(19) United States
(12) Patent Application Publication
(10) Pub. No.: US 2005/0008785 A1
(43) Pub. Date: Jan. 13, 2005

(54) Method and apparatus for coating both sides of a web

(76) Inventors: Pauli Kytonen, Tuusula (FI); Seppo Luomi, Jarvenpaa (FI); Petri Paloviita, Vantaa (FI); Pentti Rautiainen, Jarvenpaa (FI)

Correspondence Address: STIENNON & STIENNON, 612 W. MAIN ST., SUITE 201, P.O. BOX 1667, MADISON, WI, 53701-1667, US

(21) Appl. No.: 10/492,038

(22) PCT Filed: Oct. 3, 2002
(86) PCT No.: PCT/FI02/00778

(30) Foreign Application Priority Data
Oct. 8, 2001 (FI) 20011953

(51) Int. Cl. B05D 5/00; B05C 5/00

(52) U.S. Cl. 427/420; 427/209; 118/305; 118/110

(57) ABSTRACT

A coating slip is applied to a first surface (SA) of a moving paper or board web using a gravity-based application method, the web's (W) direction of travel is turned by 120-200°, then a coating slip is applied to a second surface (SB) of the web using a gravity-based application method, and both sides (SA, SB) of the web are dried. The coating applicators include application beams (11, 16), which are located above the web and which have a supply gap or supply holes to pour out the coating slip with the aid of gravity on to the surface to be coated. At the run of the web (W) remaining in between these application beams (11, 16) turning devices (22) are fitted for changing the web's direction of travel by 120-200° after coating slip has been applied to the first surface (SA) of the web

### CROSS REFERENCES TO RELATED APPLICATIONS

This application is a U.S. national stage application of International App. No. PCT/FI02/00778, filed on Oct. 3, 2002, and claims priority on Finnish Application No. FI 20011953, Filed Oct. 8, 2001.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention concerns a method for two-sided coating of a moving paper or board web.

The invention also concerns equipment for coating a moving paper or board web and including devices for applying a coating slip to a first surface of the web, devices for applying a coating slip to a second surface of the web as well as devices for drying the web, which has been coated on both sides.

In curtain coating, the coating slip is applied to the surface of the moving paper or board web from a nozzle gap located above the web transversely to the web's direction of travel, from which gap the coating slip falls on to the web surface as a curtain-like shower. Curtain coating is a contact-free coating method, wherein after the spreading of the coating slip no force is applied to the paper web in order to control the quantity of coating remaining on the web surface. For this reason, there are less breaks caused by breaking of the paper web and runnability is better than, for example, in the blade-coating method. With curtain coating a better coverage is achieved than with blade coating, but the smoothness of the coated surface is not so good.

Since the method utilizes gravity, the curtain-coating beam must always be located above the web to be coated. This makes it impossible to coat both sides of the paper or board web at the same time. A normal procedure in one-sided coating is first to coat the first side of the web, dry the web completely, turn it upside down, coat the second side and dry the coated web once again. This requires long web transfers between two coating points as well as two complete sets of drying equipment.

U.S. Pat. Nos. 4,455,327 and 5,122,386 describe methods for two-sided coating, wherein the first side of the web is coated by using some coating method known as such and the second side of the web is coated using a coating method based on a freely falling curtain. Neither publication makes known two-sided curtain coating.

### SUMMARY OF THE INVENTION

The invention aims at allowing two-sided coating of paper when using a gravity-based method for application of the coating slip.

The coating method according to the invention includes steps, wherein
a) a coating slip is applied to the first surface of the web using a gravity-based method for application of the coating slip,
b) the web's direction of travel is turned through 120-200°,
c) the coating slip is applied to the second surface of the web using a gravity-based method for application of the coating slip, and
d) both sides of the web are dried.

The web's direction of travel may be turned once again in the step where both sides of the web have been coated. A turning roll or contact-free turning device is used as the turning equipment. The web may also be dried without contact in connection with the turning equipment.

The gravity-based method for application of the coating slip may be curtain coating, coating of the MicroJet type, which is described in patent application FI 991498, or some other coating method working essentially in such a way that the application equipment must be located above the web. In MicroJet coating the coating slip is directed through holes in the nozzle plate towards the surface of the moving web. By locating the application beam above the web to be coated it is possible to utilize the force of gravity to apply the coating slip.

The advantage of contact-free coating methods based on gravity is that the coating will not load the web significantly, whereby the coating machine's runnability is good.

Significant savings in space and costs are achieved by the invention. One-sided coating can typically be performed on both sides of the web without any complete drying in between and without long transfers. Savings result due, among other things, to the fact that only one piece of drying equipment is needed and the coating machine is essentially shorter. Threading is short and free draws of the web are short, which improves the runnability of the machine.

In the following, the invention will be described in greater detail with reference to the figures shown in the appended drawings, but the intention is not to restrict the invention strictly to the details shown in these.

### BRIEF DESCRIPTION OF THE DRAWINGS

FIG. 1 shows the layout of state-of-the-art coating equipment, wherein one side at a time is coated.

FIG. 2 shows the layout of two-sided curtain-coating equipment according to the invention.

FIG. 3 shows curtain-coating equipment for two-sided coating of the web.

FIG. 4 shows curtain-coating equipment, wherein the web is dried while it is being turned around.

FIG. 5 shows an alternative layout of the equipment according to the invention.

### DESCRIPTION OF THE PREFERRED EMBODIMENTS

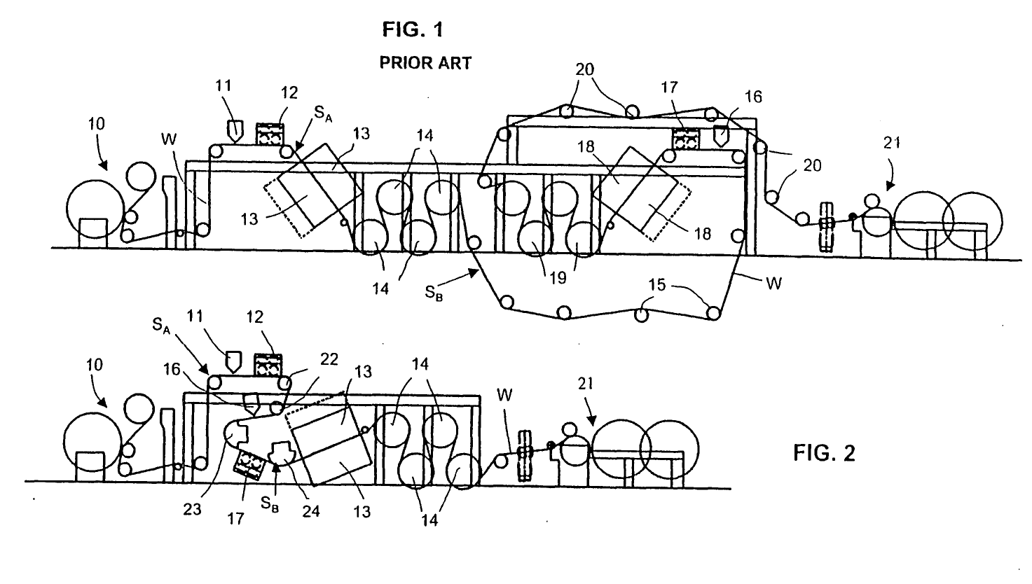

Referring to FIG. 1, the following is a study of the traditional way of performing coating of the web from one side at a time using curtain coating. A layout of a similar type is used e.g. in blade coating, which typically is a one-sided coating method.

After the unwinder 10 the paper web W is guided to travel under a first curtain-coating beam 11, from which an even layer of coating slip is applied to the upper surface SA of the moving web W as a freely falling curtain. The coated side SA of the web is first dried without contact by infra-drying equipment 12 and then both sides of the web are dried without contact by air-drying equipment 13. The drying is finished as contact drying using steam-drying cylinders 14. The web W is then transported guided by guiding rolls 15 over a relatively long distance to turn it the other way round, in order to allow coating of the other side SB of the web. Above the horizontal return run of the reversed web W a second curtain-coating beam 16 is located, which is followed by infra-drying equipment 17 to dry the coated surface SB. Following then are air-drying equipment 18 and drying cylinders 19 for two-side drying of the web. The coated web W is moved further guided by guiding rolls 20 to a reel-up 21.

FIG. 2 illustrates how much the length of the coating machine is reduced by the way according to the invention of coating both sides of the web almost simultaneously. Partly the same reference numbers as in FIG. 1 are used for parts corresponding to each other. To the first surface SA of the web W a coating slip is applied using a first curtain-coating beam 11, and the coated side is dried without contact using infra-drying equipment 12. Then the traveling direction of the web W is changed with the aid of two successive turning rolls 22 so much that after the change of direction the web will travel obliquely downwards towards the incoming direction of the web W. At this stage a layer of coating slip is applied to the second surface SB of web W by a second curtain-coating beam 16, which is fitted above the web W on its run traveling obliquely downwards. The web's direction of travel is again changed with the aid of two contact-free turning devices 23 and 24, whereby in the area remaining in between these devices the web's surface SB, which was coated last, is dried by infra-drying equipment 17. Then the completely coated web W is dried with the aid of air-drying equipment 13 and steam-drying cylinders 14.

The advantages which can be achieved with the invention emerge clearly when comparing FIGS. 1 and 2. When both sides of the web are coated one after the other without any drying in between, only one set of expensive and bulky drying equipment 13, 14 is needed for two-sided drying of the web and the coating machine is much shorter. The free web transfers are short and the threading is also short.

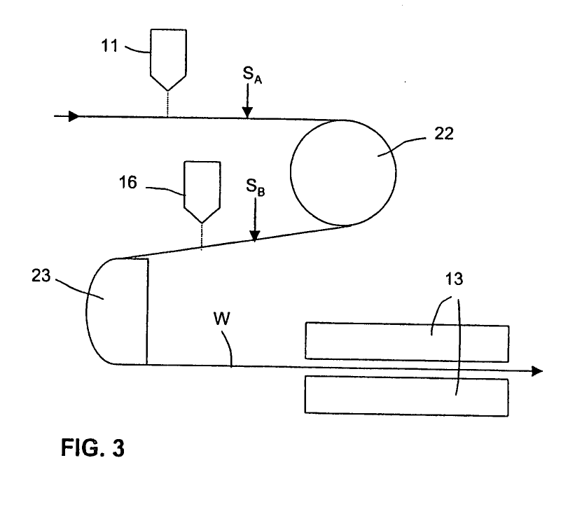

FIG. 3 shows the principle of the curtain-coating equipment according to the invention, wherein the direction of travel of the web W to be coated is from above left down to the right and wherein the web's W direction of travel is turned around twice. Above the first run of the web a first curtain-coating beam 11 is located, from which a layer of coating slip is dropped as a uniform curtain on to the first surface SA of web W. Then the web's W direction of travel is changed with the aid of one or more turning rolls 22 by 120-200° in such a way that after the turning roll 22 the web W will travel obliquely downwards towards its incoming direction. At the web section following after the change of direction a second curtain-coating beam 16 is located above the web W and from this beam a layer of coating slip falls as a uniform curtain on to the second surface SB of web W. The direction of travel of the web W, which has now been coated on both sides, is changed for a second time with the aid of a contact-free turning device 23 in such a way that the web W will once again travel in its original direction. The turning device 23 may be e.g. a TurnFloat turning device made by Metso Paper. Inc., wherein an air flow is blown against the web's W coated surface SA. Hereby an air cushion is formed between the web W and the turning device 23 to keep the moist and coated web W separate from the surface of the turning device 23. After one or more turning devices 23 the web is guided into an air-drying device 13, wherein both sides of the coated web W are dried at the same time.

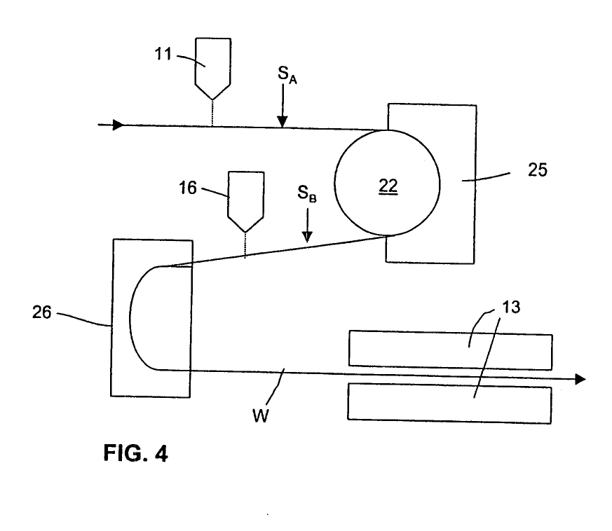

FIG. 4 shows a solution, wherein the web's W coated surfaces SA, SB are dried without contact in connection with the change in the direction of travel of the web. In connection with the turning roll 22 following after coating of the first side SA it is possible to use e.g. an air impingement drier 25. After the second curtain-coating beam 16 both surfaces SA, SB of the web are wet, for which reason it is advantageous for the turning to use a turning-and-drying device 26 drying the web without contact on both sides, which device 26 is e.g. the turning-and-drying device made by the applicant under the product name TurnDry.

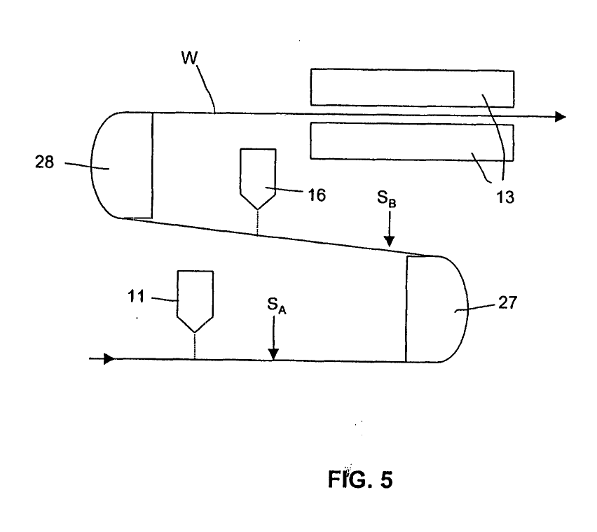

FIG. 5 shows a solution, wherein after the first curtain-coating beam 11 a first turning device 27 is used to turn the web W upwards to travel obliquely upwards towards the web's W incoming direction. At this section a second curtain-coating beam 16 is located above the web, whereupon the web's W direction of travel is changed with the aid of a second turning device 28 in such a way that it will once again travel in its original outgoing direction.

Instead of the curtain-coating beam there may be some other gravity-based coating device, such as, for example, a MicroJet beam, which is located above the web and where the coating is brought to the web from a distribution chamber through a sieve in the form of small jets, which merge on the web forming a coherent coating surface.

Although FIGS. 2-5 show such a form of application only, wherein the web's direction of travel is turned twice by 120-200°, itis possible to embody the invention also in such a way that the web's direction of travel is changed only once.

In the following the claims are presented, which define the inventive idea, within the scope of which the various details of the invention may vary and differ from the above presentation, which was given by way of example only.

1-9. (cancelled)

10. A method for two-sided coating of a moving paper or board web which has a first surface on one side of the web, and a second surface on an opposite side of the web, comprising the steps of:
applying an even layer of coating slip as a freely falling curtain to the first surface of the web which faces upwardly, by utilizing the force of gravity to apply the coating slip;
after applying the coating slip to the first surface, turning the web's direction of travel around by 120-200°;
before contact-drying the first surface after applying the first coating, applying an even layer of coating slip as a freely falling curtain to the second surface of the web which faces upwardly, utilizing the force of gravity to apply the coating slip; and
contact drying both sides of the web.

11. The method of claim 10 further comprising the step of turning the web's direction of travel a second time by 120-200° after the step of applying the coating slip to the second surface.

12. The method of claim 10 further comprising drying the web without contact while performing the step of turning the web's direction of travel around by 120-200°.

13. The method of claim 10 wherein a curtain-coating beam is used to apply the coating slip to the web's surface.

14. The method of claim 10 wherein the step of applying a coating slip to the first surface of the web comprises pouring out the coating slip onto the first surface through holes within an application beam located above the web.

15. A method for two-sided coating of a paper or board web moving in a direction of travel from an incoming position, comprising the steps of:
applying a coating slip to a first surface of the web from a nozzle gap located above the web transversely to the web's direction of travel such that the coating slip falls on to the first web surface as a curtain-like shower;
drying the coated first side without contact drying prior to applying a coating slip to the second surface of the web;
changing the traveling direction of the web by 120-200° by passing the web over two successive turning rolls so that after the change of direction, the web travels obliquely downwards towards the incoming position of the web;
applying a coating slip to a second surface of the web which is opposite the first surface, the coating slip being applied from a nozzle gap located above the web transversely to the web's direction of travel such that the coating slip falls on to the second web surface as a curtain-like shower;
changing the web's direction of travel by passing the web over two contact-free turning devices;
drying the web as it moves between the two contact-free turning devices with an infra-drying apparatus; and
drying the web which has been coated on the first surface and the second surface with air-drying equipment and steam-drying cylinders.

16. An apparatus for coating a moving paper or board web having a first surface and an opposite second surface, comprising:
rolls positioned to cause the paper or board web first surface to face upwardly;
a device for applying a coating slip to the first surface of the web while it faces upwardly, the device having a first application beam located above the web, the beam having a supply gap or supply holes to pour out the coating slip with the aid of gravity to from a freely falling curtain which falls on to the first surface;
turning devices to change the web's direction of travel by 120-200° after the coating slip has been applied to the first surface of the web, said turning devices being positioned at a run of the web in between the first application beam and a second application beam, said turning devices positioned to cause the paper or board web second surface to face upwardly;
a device for applying a coating slip to the second surface of the web while it faces upwardly, the device including a second application beam located above the web, the beam having a supply gap or supply holes to pour out the coating slip with the aid of gravity to from a freely falling curtain which falls by gravity on to the second surface; and
a contact dryer for drying the web after it has been coated on the first surface and the second surface, after the device for applying coating slip to the first surface, there being no contact dryer engaging the first surface prior to the device for applying a coating slip to the second surface of the web.

17. The apparatus of claim 16 further comprising devices for changing the web's direction of travel by 120-200° after the device for applying a coating slip to the second surface of the web.

18. The apparatus of claim 16 wherein the turning devices are combined with drying devices to allow contact-free drying of one or both coated surfaces of the web.

19. The apparatus of claim 16 wherein the devices for applying the coating slip to the web surface include a curtain-coating beam.

20. An apparatus for coating a two-sided paper or board web, the web having a first surface on a first side and a second surface on a second side, the apparatus comprising:
a first curtain-coating beam located above a first run of the web, the first curtain-coating beam having coating apparatus from which a layer of coating slip is dropped as a uniform curtain on to the first surface of the web;
at least one turning roll positioned after the first curtain-coating beam, the at least one turning roll turning the direction of travel of the web by 120-200° such that after the at least one turning roll the web travels obliquely downwards towards an incoming direction to define a second run downstream of the first run, the second run being ahead of any contact drying of the coated first surface of the web;
a second curtain-coating beam located above the second run of the web, the second curtain-coating beam having coating apparatus from which a layer of coating slip falls as a uniform curtain on to the second surface of the web;
a contact-free turning device positioned downstream of the second curtain-coating beam, the contact-free turning device turning the web changing the direction of the web to travel away from the incoming direction; and
an air-drying device downstream of the contact-free turning device which dries both sides of the coated web.

21. The apparatus of claim 20 wherein the contact-free turning device is a turning-and-drying device.

22. The device of claim 20, wherein the contact-free turning device blows an air flow against the web.
